(19) United States
(12) Patent Application Publication
(10) Pub. No.: US 2005/0015408 A1
(43) Pub. Date: Jan. 20, 2005

(54) Method for rewriting data in a memory

(76) Inventor: Yoshihiro Shona, Tokyo (JP)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/759,096

(22) Filed: Jan. 20, 2004

(30) Foreign Application Priority Data
Jul. 15, 2003 (JP) 2003-274737

(51) Int. Cl. G06F 12/00

(52) U.S. Cl. 707/200

(57) ABSTRACT

An improved method of rewriting data in a memory is provided. A flash memory has a sector partitioned into a plurality of areas. In the flash memory, data are written to a same position in the respective areas. When writing rewrite data, an exclusive-OR of the rewrite data and data at a target position in a first area is taken, and an exclusive-OR of the exclusive-OR data and data at the same position in a second area is taken. Similar steps are repeated in sequence for the rest of the areas. In the course of repeating these steps, when data at the target position of the area concerned are an initial value, then the most recent exclusive-OR data are written to the position in that area.

### BACKGROUND OF THE INVENTION

1. Field of the Invention

The present invention relates to methods for rewriting data in a memory such as a flash memory.

2. Description of the Related Art

Conventionally, if a data write region in a flash memory is split into a plurality of data blocks, and rewrite data should be written to a certain data block, then the data of that data block are erased and the rewrite data are written onto that data block. This data writing method is disclosed in, for example, Japanese Patent Application Kokai No. 6-324945 (particularly, page 3, and FIGS. 9 and 10 are relevant).

The data rewriting method of Japanese Patent Application Kokai No. 6-324945, however, has the disadvantage that the rewriting time is too long, and thus practically the method cannot be adopted, when it is necessary to rewrite a non-volatile memory that can be rewritten in several mS, such as a contact-type IC card or a contactless IC card.

There is also the disadvantage that when rewriting data in single byte or single word units, data are rewritten after deleting data in units of one sector (page), and thus sections for which there is no need to rewrite are rewritten also, thereby increasing the number of times that rewriting is performed. This ran the risk of speeding up deterioration of the memory cell.

The number of times rewriting is performed can be reduced by providing select transistors to allow erasing in byte units or in word units, but this requires the addition of select transistors to the memory cells, which significantly increases the size of flash memory.

### SUMMARY OF THE INVENTION

According to one aspect of the present invention, there is provided an improved method of rewriting data in a memory. The memory has a sector partitioned into a plurality of areas. In the memory, data are written to a same position in the areas. When writing rewrite data, an exclusive-OR of the rewrite data and data at a target position (position to be rewritten) in a first area is taken. Then, an exclusive-OR of the exclusive-OR data and data at the same position in a second area is taken. Subsequently, similar XORing is performed for the following areas. In the course of these XORing steps, when data at the target position in the area concerned are an initial value, then the most recent exclusive-OR data are written to the target position in that area.

It is possible to rewrite the data at faster speeds than in conventional data rewriting because data are not erased. Since a single sector is partitioned into a plurality of areas, the number of times the same cell is rewritten can be reduced, and deterioration of the memory cells can be prevented. Data can be rewritten in byte units or in word units without introducing select transistors so that the memory size can be kept small.

Other objects, aspects and advantages of the present invention will become apparent to those skilled in the art to which the present invention relates from the subsequent detailed description and the appended claims, taken in conjunction with the accompanying drawings.

### BRIEF DESCRIPTION OF THE DRAWINGS

FIG. 1 illustrates a flash memory, a working memory and associated parts used for a method of rewriting data in the flash memory according to a first embodiment of the present invention.

FIG. 2 is a flowchart showing the operation when rewriting the data according to the first embodiment.

FIG. 3 is a flowchart showing the operation when reading the data according to the first embodiment.

FIG. 4A to 4D are a set of diagrams showing how the data are rewritten three times from an initial state.

FIG. 5 illustrates a flash memory, a working memory and other elements used in a method for rewriting data in the flash memory according to a second embodiment of the present invention.

FIG. 6 is a flowchart showing the operation when rewriting data according to the second embodiment.

FIG. 7 illustrates a flash memory, a working memory and other elements used in a method for rewriting the data in the flash memory according to a third embodiment of the present invention.

FIG. 8 is a flowchart showing the operation when rewriting data according to the third embodiment.

FIG. 9 is a flowchart showing the operation when reading data according to the third embodiment.

FIG. 10 is a flowchart showing the operation when reading a pointer according to the third embodiment.

FIG. 11 is a flowchart showing the operation when rewriting the pointer according to the third embodiment.

FIG. 12 illustrates a flash memory, a working memory and other parts used in a method for rewriting the data in the flash memory according to a fourth embodiment of the present invention.

FIG. 13 is a flowchart showing the operation when rewriting data according to the fourth embodiment.

FIG. 14 is a flowchart showing the operation when reading data according to the fourth embodiment.

FIG. 15 illustrates a flash memory, a working memory and other elements used in a method for rewriting the data in the flash memory according to a fifth embodiment of the present invention.

FIG. 16 is a flowchart showing the operation when rewriting data according to the fifth embodiment.

FIG. 17 is a flowchart showing the operation when reading data according to the fifth embodiment.

FIG. 18A to 18E are a set of diagrams used to explain a method for rewriting the data in a memory according to a sixth embodiment of the present invention.

FIG. 19 is a flowchart showing the operation when rewriting data according to the sixth embodiment.

FIG. 20A to 20K illustrate the changing states of the sectors as the data rewrite process proceeds.

FIG. 21 is a flowchart showing the operation when reading data according to the sixth embodiment.

FIG. 22 is a diagram of memories and a cache memory used in a method for rewriting the data in the memories according to a seventh embodiment of the present invention.

### DETAILED DESCRIPTION OF THE INVENTION

### FIRST EMBODIMENT

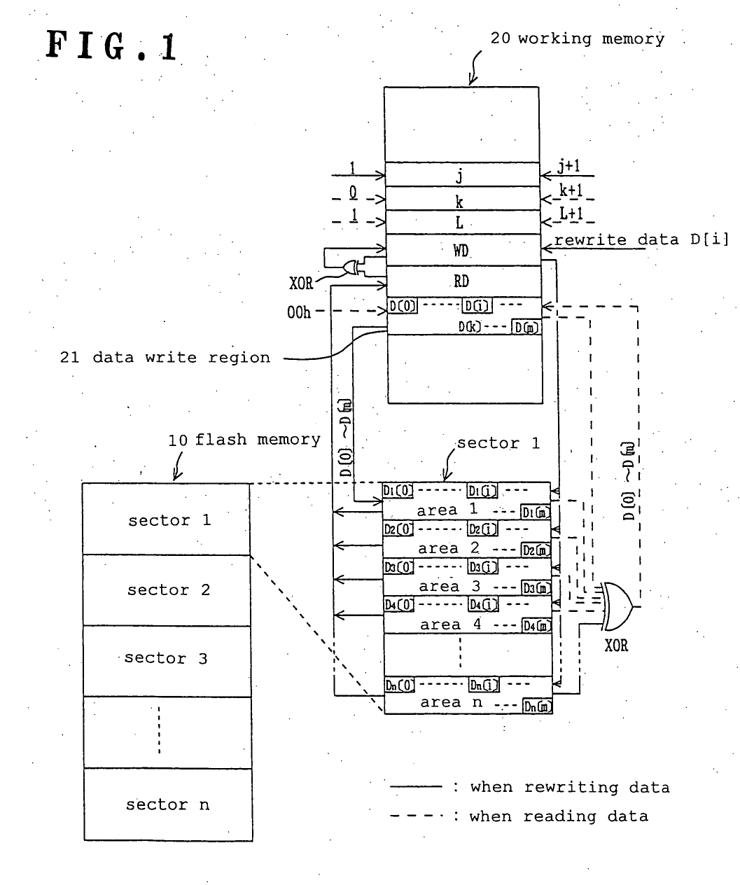

Referring to FIG. 1, a method for rewriting data in a memory according to a first embodiment of the invention will be described. It should be noted that in the diagram, the solid arrows indicate the flow of data when data are being rewritten and the dashed arrows indicate the flow of data when data are being read.

A memory of the first embodiment is for example a flash memory 10, which is divided into a plurality of sectors 1 to n. A fixed number of bytes that can be deleted at one time serve as a single sector. Of the sectors, the sector 1 is divided into a plurality of areas 1 to n, each a size of m bytes, for data rewriting. The areas 1 to n make up a single sector 1, as described above, and thus can all be deleted at one time in a single deletion process. On the other hand, the areas 1 to n are configured so that writing can be carried out in one-byte units. It should be noted that the erased and written states of the flash memory 10 are normally represented by a “0” and a “1”, or “1” and “0,” respectively, depending on the memory cell format and the read method. In the following description, the erased state is “0” and the written state is “.”

The system includes, other than the flash memory 10, a control portion (not shown) such as a CPU for controlling the overall system, a program memory (not shown) such as a ROM in which the control program is stored, and a working memory 20 such as a RAM for temporarily holding various types of data. The working memory 20 has a variable region j to which the area numbers used when rewriting data are written, a second variable region k to which are written the data numbers for respective areas used when reading data, a third variable region L to which are written the area numbers used when reading data, a fourth variable region WD in which are written the rewrite data and XOR data obtained by XORing the rewrite data, a fifth variable region RD in which data stored in the respective areas are written, and a data write region 21 for temporarily storing the true data that are obtained by XORing the data of the respective areas.

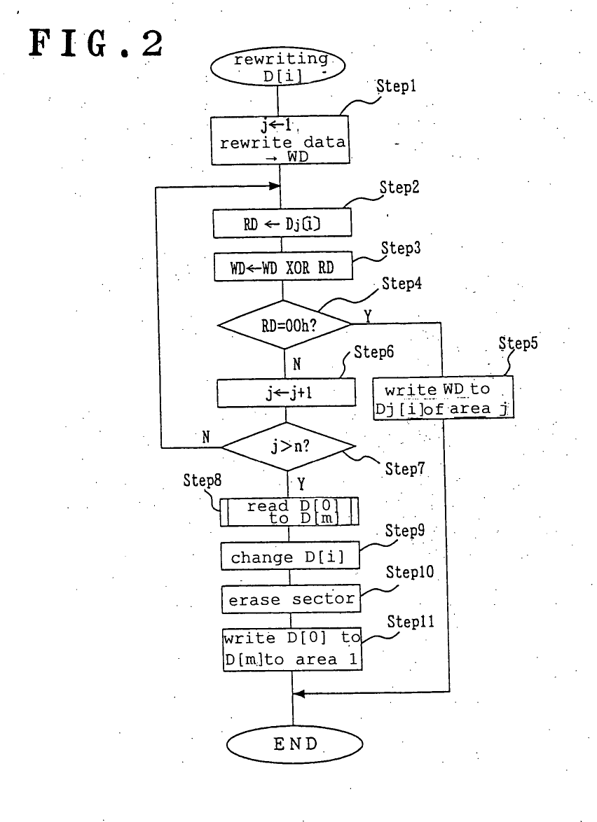

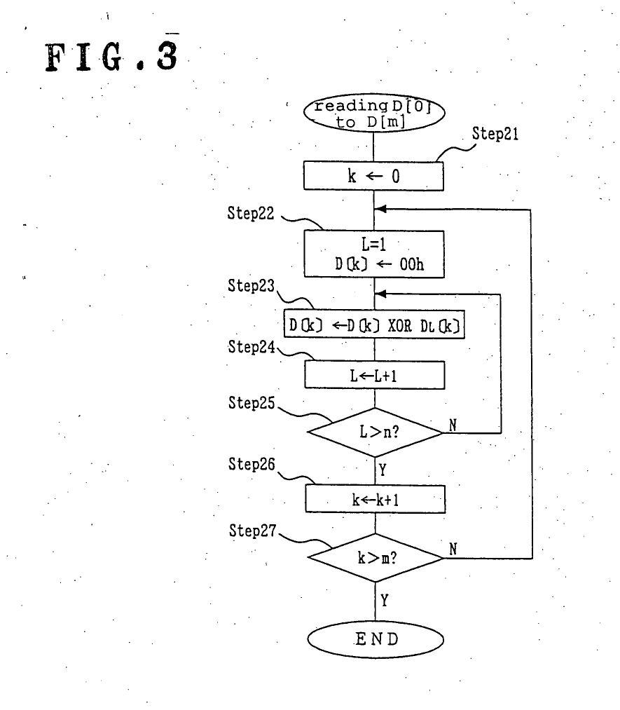

Next, the operation of the system having the flash memory 10 will be described using the flowcharts of FIG. 2 and FIG. 3. FIG. 2 is a flowchart showing the operation when rewriting data, and FIG. 3 is a flowchart showing the operation when reading data. It should be noted that the flowchart of FIG. 2 is an example in which data D[i] are rewritten. First, the operation when D1[i] to Dn[i] of the areas 1 to n are in the erased state of “00 h” is described, and then the operation when data are written to D1[i] to Dn[i] is described.

When the control portion detects the input of one byte of rewrite data D[i], the control portion first writes a “1,” which is the area number of the sector 1 of the flash memory 10, onto the variable region j of the working memory 20 and then writes the rewrite data D[i] onto the variable region WD of the working memory 20 (Step 1). Next, the control portion writes the i-th data of the area j, which in this case are the i-th data D1[i] of the area 1, to the variable region RD of the working memory 20 (Step 2). Then, the control portion takes the XOR (exclusive OR) of the rewrite data D[i] and the data D1[i] written to the variable regions WD and RD, respectively, and writes the resulting XOR data over the rewrite data D[i] in the variable region WD (Step 3). Subsequently, the control portion determines whether the data D1[i] of the area 1, which are written to the variable region RD of the working memory 20, are 00 h (Step 4). When the data D1[i] are not 00 h, the control portion increments the variable region j by 1 to 2 (Step 6). When the data D1[i] of the area 1, which are written onto the variable region RD, are 00 h, then the control portion writes the XOR data onto the variable region WD over the data D1[i] of the area 1 (Step 5), and ends the series of operations described above. In this case, the data written onto D1[i] of the area 1 are 00 h and thus the true rewrite data D[i] that are received are written on the data D1[i].

When the second rewrite data D[i] are received by the control portion, the control portion writes a 1, which specifies the area of the sector 1 of the flash memory 10, to the variable region j of the working memory 20, and writes the rewrite data D[i] onto the variable region WD of the working memory 20 (Step 1). Next, the control portion writes the i-th data D1[i] of the area 1 to the variable region RD of the working memory 20 (Step 2). The control portion then takes the XOR of the rewrite data D[i] and the data D1[i] written onto the variable regions WD and RD, respectively, and writes the resulting XOR data over the data D[i] in the variable region WD (Step 3). Then, the control portion determines whether the data D1[i] of the area 1, which are written to the variable region RD of the working memory 20, are 00 h (Step 4). In this case, as discussed above, since the data D1[i] of the area 1 are not “00 h,” the control portion increments the variable region j by 1 to 2 (Step 6), and determines whether the value of the variable region j exceeds the area number n of the sector 1 (Step 7). If the value of the variable region j exceeds n, all data D[0] to D[m] within the sector 1 are read (Step 8). At this point, since the value of the variable region j is 2 and is less than n, the i-th data D2[i] of the next area, which is the area 2, are read and written over the data D1[i] of the variable region RD (Step 2).

Next, the control portion takes the XOR of the data D2[i] and the previous XOR data written onto the variable region WD, and writes the resulting new XOR data over the XOR data in the variable region WD (Step 3). Then, as described above, the control portion determines whether the data D2[i] of the area 2, which are written to the variable region RD, are 00 h (Step 4). In this case, since the data D2[i] of the area 2 are 00 h, the control portion writes the new XOR data in the variable region WD over the data D2[i] of the area 2 (Step 5), and ends the data rewriting process.

When the third rewrite data D[i] are received, the control portion writes a 1 specifying the area of the sector 1 to the variable region j of the working memory 20, and writes the rewrite data D[i] to the variable region WD of the working memory 20 (Step 1). Next, the control portion writes the i-th data D1[i] of the area 1 to the variable region RD of the working memory 20 (Step 2). The control portion then takes the XOR of the rewrite data D[i] and the data D1[i] written to the variable regions WD and RD, respectively, and writes the resulting XOR data over the rewrite data D[i] of the variable region WD (Step 3). Then, the control portion determines whether the data D1[i] of the area 1, which are written onto the variable region RD of the working memory 20, are 00 h (Step 4). Since the data D1[i] of the area 1 are not 00 h, the control portion increments the variable region j by 1 to 2 (Step 6), and determines whether the value of the variable region j exceeds the area number n of the sector 1 (Step 7). Since the value of the variable region j is 2 and is not greater than n, the control portion reads the i-th data D2[i] of the area 2, whose area number is 2, and writes it over the data D1[i] of the variable region RD (Step 2).

Next, the control portion takes the XOR of the data D2[i] and the previous XOR data written to the variable region WD and writes the resulting new XOR data over the XOR data within the variable region WD (Step 3). Then, the control portion determines whether the data D2[i] of the area 2 written to the variable region RD are 00 h (Step 4). Since at this time the data D2[i] of the area 2 are not 00 h, the control portion increments the variable region j by 1 to 3 (Step 6), and determines whether the value of the variable region j exceeds n which is the area number of the sector 1 (Step 7). Since the value of the variable region j is 3 and is not greater than n, the i-th data D3[i] of the area 3, whose area number is 3, are read and written over the data D2[i] of the variable region RD (Step 2).

Next, the control portion takes the XOR of the data D3[i] and the XOR data written to the variable region WD, and writes the resulting XOR data over the XOR data in the variable region WD (Step 3). Then, the control portion determines whether the data D3[i] of the area 3 that are written to the variable region RD are 00 h (Step 4). Since at this time the data D3[i] of the area 3 are 00 h, the XOR data within the variable region WD are written over the data D3[i] of the area 3 (Step 5), and the data rewrite process is ended. The rewriting of data through the above-described operations of Step 1 to Step 7 can be performed up to n number of times.

The operation when data other than 00 h are written onto D1[i] to Dn[i] of the areas 1 to n is described next.

This case is the case when rewrite data D[i] are input after the n-th rewrite data. The control portion repeatedly takes the XOR of the write data D[i] and the data D1[i] to Dn[i] of the areas 1 to n of the sector 1, and then in Step 7 determines whether the value of the variable region j is greater than n. In this case, the value is greater than n, and thus the control portion enters the read procedure for reading the true data D[0] to D[m] from the data D1[0] to Dn[m] written to the sector 1 of the flash memory 10 (Step 8). This reading procedure is described later using FIG. 3. The true data D[0] to D[m] that are read in Step 8 are temporarily stored in the data write region 21 of the working memory 20, and the data D[i] of the true data D[0] to D[m] stored in the working memory 20 are overwritten and changed to the rewrite data D[i] (Step 9). Next, all data D1[0] to Dn[m] written onto the sector 1 of the flash memory 10 are erased (Step 10), and then the true data D[0] to D[m] for which the change of the data D[i] has ended are read from the working memory 20 and written to the area 1 of the sector 1 of the flash memory 10 (Step 11). Thus, the process of rewriting the rewrite data D[i] is ended.

The operation when data are read is described using the flowchart shown in FIG. 3.

When the control portion enters the process for reading the true data D1[0] to Dn[m] in Step 8 shown in FIG. 2, first the control portion writes a 0, which is the arrangement order of the data written to the areas 1 to n of the sector 1, to the variable region k of the working memory 20 (Step 21). Next, the control portion writes the area number “1” of the sector 1 of the flash memory 10 to the variable region L of the working memory 20 and also writes the erased state of 00 h to D[k], which in this case is D[0], of the data write region 21 of the working memory 20, thereby setting it to data D[0] (Step 22).

Then, the control portion reads the k-th data DL[k] of the area L of the sector 1, which at this point is the first data D1[0] of the area 1, and takes the XOR of this data and the data D[0] of the data write region 21. The control portion writes the resulting XOR data over the 00 h of the data D[0] of the data write region 21 (Step 23). Subsequently, the variable region L is incremented by 1 to 2 (Step 24). The control portion determines whether this value is greater than the area number n of the sector 1 (Step 25). If the value of the variable region L is greater than n, then the control portion determines that the true data D[0] have been written to the data write region 21 as a result of repeating the operations of Steps 23 to 25. The procedure advances to Step 26 in order to read the next data row. At this point, however, the value of the variable region L is 2 and is not greater than n, and thus the procedure returns to Step 23.

Then, the control portion reads the first data D2[0] of the area 2, takes the XOR of the first data D2[0] and the XOR data D[0] written onto the data write region 21, and writes the resulting new XOR data over the XOR data D[0] of the data write region 21 (Step 23). After that, the control portion increments the variable region L by 1 to 3 (Step 24), and determines whether the incremented value is greater than the area number “n” of the sector 1 (Step 25). The operations of Step 23 to Step 25 are performed repeatedly until the true data D[0] is read from the first data D1[0] to Dn[0] of the areas 1 to n as discussed above. When the value of the variable region L is greater than n, the variable region k is incremented by 1 and set to 1 (Step 26). The control portion determines whether that value is greater than m (Step 27). If the value of the variable region k exceeds m, then the control portion determines (considers) that the true data D[0] to D[m] have been read from all the data D1[0] to Dn[m] written to the areas 1 to n of the sector 1, and ends the procedure. However, since the value of the variable region k is 1, the procedure returns to Step 22 and the variable region L is once again set to 1. Then, the erased state of 00 h is written to D[k], which in this case is D[1], of the data write region 21 of the working memory 20, thereby setting it to data D[1].

Subsequently, the control portion reads the second data D1[1] of the area 1, takes the XOR of the second data D1[1] and the data D[1] of the data write region 21, and writes the resulting XOR data over the 00 h of the data D[1] of the data write region 21 (Step 23). The control portion increments 1 to 2 in the variable region L (Step 24), and determines whether this value is greater than the area number n of the sector 1 (Step 25). At this point, since the value of the variable region L is 2 and does not exceed n, the procedure returns to Step 23 and the operations of Step 23 to Step 25 are repeated until the area number of the sector 1 becomes n. Then, 1 is incremented to 2 in the variable region k (Step 26), and the control portion determines whether this value is greater than m (Step 27). At this point, the value of the variable region k is 2, and thus the procedure returns to Step 22 to repeat the above series of operations (Steps 22 to 27) until the true data D[m] is read from the m-th data D1[m] to Dn[m] of the areas 1 to n. When the true data D[0] to D[m] have been written to the data write region 21 of the working memory 20 through repeating Steps 22 to 27, the data reading procedure ends.

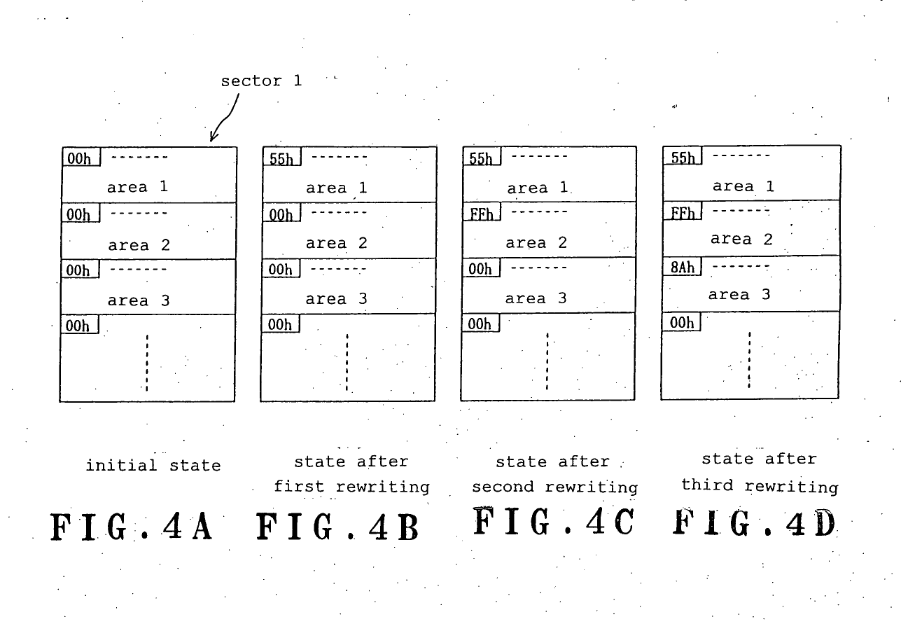

Here, the status of the data in a case where the areas 1 to n of the sector 1 of the flash memory 10 are in the erased state (00 h) and the data are rewritten is described in detail using FIG. 4A to FIG. 4D. FIG. 4A to FIG. 4D show the rewrite state of the data when the data are rewritten three times.

To write the rewrite data “55 h” to the first D[0] when all of the data of the areas 1 to n are 00 h (see FIG. 4A), first, 55 h is written to the variable region WD of the working memory 20 and then the 00 h of the first D1[0] of the area 1 is read and written to the variable region RD of the working memory 20. After that, the XOR of 55 h and 00 h written to the variable regions WD and RD, respectively, is taken and the resulting 55 h is written over the 55 h in the variable region WD. Then, it is determined whether the data written to the variable region RD of the working memory 20 are 00 h. Since the data are 00 h, the 55 h written to the variable region WD is written over 00 h of D1[0] in the area 1 (see FIG. 4B).

Next, if the data of 55 h is to be rewritten with AAh, then as discussed above, AAh is written to the variable region WD and the 55 h of the first D1[0] of the area 1 is read and written to the variable region RD. The XOR of AAh and 55 h written to the variable regions WD and RD, respectively, is then taken, and the FFh that results is written over the AAh of the variable region WD. Then, it is determined whether the data written to the variable region RD are 00 h. Since in this case the data are 55 h, the first D2[0] of the area 2 is accessed and 00 h is read and written over the 55 h of the variable region RD. The XOR of the 00 h that was written over the 55 h and the FFh of the variable region WD is taken and the resulting FFh is written over the variable region WD. Then, whether the first data of the second area 2 that were written to the variable region RD are 00 h is determined. Since in this case the data are 00 h, the FFh that was written to the variable region WD is written over the 00 h of the D2[0] of the area 2 (see FIG. 4C). Also, if it is to be rewritten to 20 h as a third rewriting, then 8 Ah (55 h XOR FFh XOR 20 h=8 Ah) is written over 00 h of the D3[0] of the area 3. (see FIG. 4D).

It should be noted that when reading data from the state of FIG. 4D, first 00 h is set to D[0] of the data rewrite region 21 of the working memory 20, then the XOR of this 00 h and the 55 h of the area 1 is taken, then the XOR of the resulting XOR value and the FFh of the area 2 is taken, and lastly the XOR of this XOR value and the 8 Ah of the area 3 is taken, so that the data 20 h written in the third rewriting is read out.

As described above, in the first embodiment, one sector (sector 1) of the flash memory 10 is partitioned into a plurality of areas 1 to n each m bytes in size, and when writing rewrite data, the XOR of the data concerned and the data of the areas 1 to n is repeatedly taken while it is saved in the 00 h areas. Thus, data can be rewritten faster than was the case with conventional data rewriting because data are not erased.

Also, as described above, since the sector 1 is used partitioned into a plurality of areas 1 to n, the number of times that the same cell is rewritten can be reduced, thereby preventing deterioration of the memory cells and allowing data to be rewritten in byte units or in word units without introducing selector transistors. Thus, the memory size can be reduced.

Also, since the data that are written to the areas 1 to n are XOR data and have not been written directly, it is difficult for a third party with nefarious intentions to analyze the data of the flash memory 10, and in this regard an improvement in security can be achieved.

Moreover, according to the first embodiment, when rewrite data should be written but there are no empty areas among the areas 1 to n, then the data of the areas 1 to n are erased. However, this erasing is performed only once every n times, and thus the invention according to the first embodiment can be adopted for IC cards, for example, which require the rewriting of data only for specific regions. Furthermore, the invention of the first embodiment can be employed for contactless IC card passenger tickets. Although high-speed rewriting is required at ticket gates, rewriting at fare adjustment machines can be carried out relatively slowly. Thus, if the sector 1 has a sufficiently large number of areas, and the rewriting of data, including erasing, is performed during fare adjustment, then the invention of the first embodiment can be adopted for passenger tickets.

### SECOND EMBODIMENT

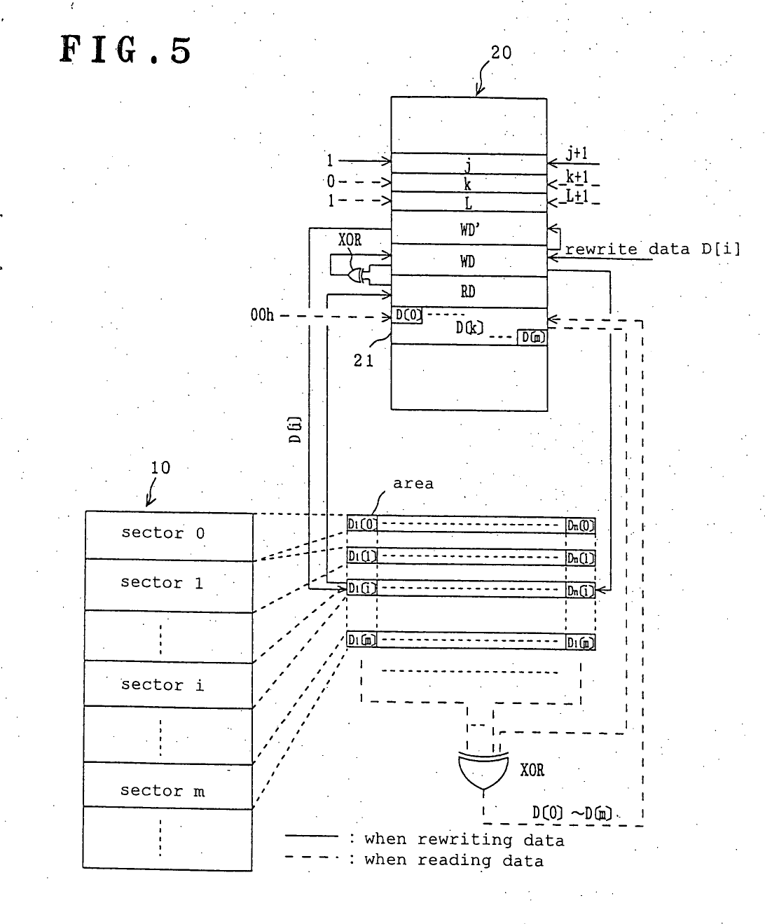

FIG. 5 is an explanatory diagram of the method for rewriting data in a memory according to a second embodiment of the present invention.

In the second embodiment, as shown in the diagram, sectors of the flash memory 10 are prepared in accordance with the number of data and one sector is for example used for storing 1 byte of data. That is, in the case of writing data D[0] to D[m], then m+1 sectors 0 to m are prepared and each of the sectors 0 to m is made of n bytes.

The working memory 20 has a variable region j to which an area number for a sector used when rewriting data is written, a variable region k to which a sector number used when reading data is written, a variable region L to which an area number of a sector used when reading data is written, a variable region WD′ for holding the rewrite data, a variable region WD in which the rewrite data and the XOR data of the rewrite data are written, a variable region RD to which data D1[0] to Dn[m] stored in the areas of the sectors 0 to m are written, and a data write region 21 for temporarily storing the true data D[0] to D[m] that are obtained by XORing the data of the sectors 0 to m.

The operation when rewriting data according to the second embodiment is described next using the flowchart of FIG. 6. It should be noted that steps that are identical to those of the first embodiment shown in FIG. 2 (Steps 2 to 7) are assigned identical step numbers and a detailed description of the operation of these steps is omitted.

When the control portion (not shown) detects the input of one byte of rewrite data D[i], the control portion first writes the rewrite data D[i] to the variable region WD of the working memory 20 and then writes 1, which indicates the area order of the sector i, to the variable region j of the working memory 20 and writes the rewrite data D[i] that were written to the variable region WD to the variable region WD′ (Step 1′).

Next, as described in the first embodiment, when data Dj[i] of 00 h are confirmed before the area number j of the sector i exceeds n, then data that have been XORed are read from the variable region WD and written to that area. When the dataDj[i] of 00 h is not found and the area number j exceeds n (Step 2 to Step 7), then all data D1[i] to Dn[i] written to the sector i are erased (Step 10). Subsequently, the rewrite data D[i] are read from the variable region WD′ and written to the first area of the sector i (Step 11′), and the rewriting process for the rewrite data D[i] is ended.

It should be noted that the process of reading all the data D[0] to D[m] written to the sectors 0 to m is similar to that of the first embodiment (see FIG. 3). The difference lies in that the readout data D[0] to D[m] are obtained by taking the XOR of the data of the respective sectors. In the second embodiment, the same number of sectors as the number of data is prepared.

As described above, according to the second embodiment, sectors having n areas (n bytes) per one byte of data are provided and XORed data are written to the areas each instance of rewriting, and thus like the first embodiment, deterioration of the memory cells can be prevented, data can be rewritten in byte units or in word units without introducing selector transistors, and an improvement in security can be expected.

Also, if the areas within the sector for the write data become full with XOR data, then instead of reading out all the data D[0] to D[m], only data in that sector are erased before the rewrite data are written. Thus, the process is simpler than in the first embodiment and the process time is shorter.

Moreover, since one byte of data is written per sector, data other than data that have been targeted for rewriting are not erased. Thus, concern that the data other than the target data do not become corrupted due to incomplete (interrupted) writing of new data is eliminated.

### THIRD EMBODIMENT

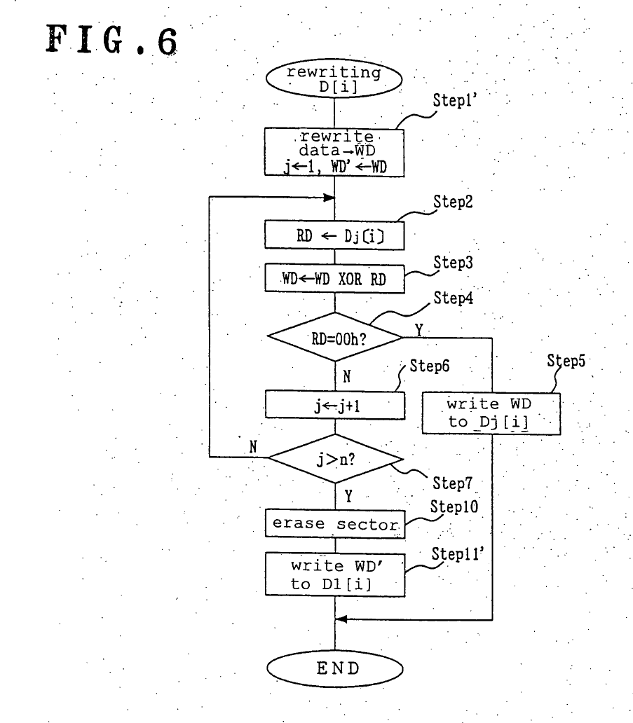

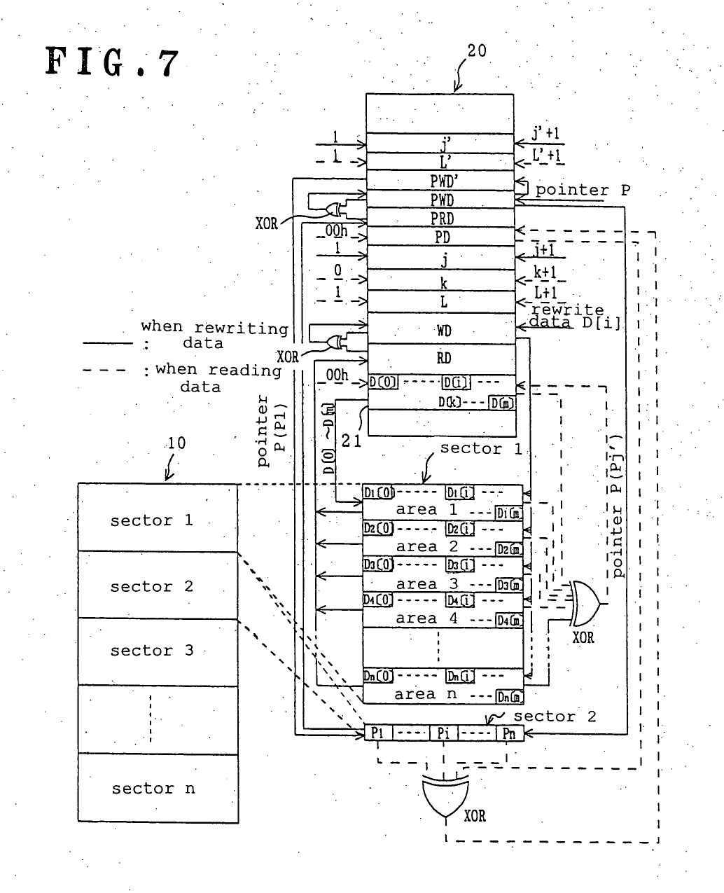

FIG. 7 is an explanatory diagram of a method for rewriting data in a memory according to a third embodiment of the present invention. It should be noted that components that are identical to or correspond to those of the first and second embodiments illustrated in FIG. 1 and FIG. 5 have been assigned identical reference numerals and description thereof is omitted.

The flash memory 10 of the third embodiment has a sector 1 for data writing and a sector 2 for storing one-byte pointer data P (hereinafter, referred to simply as “pointer P”), for example. The sector 1 is partitioned into a plurality of areas 1 to n each m bytes in size, like in the first embodiment, and the sector 2 is made of n bytes. The pointer P indicates an area number of an area in which data are written.

The working memory 20 has the same write regions as in the first embodiment, and additionally has a variable region j′ to which the area number of the sector 2 used when rewriting the pointer P is written, a variable region L′ to which the area number of the sector 2 that is used when reading the pointer P is written, a variable region PWD′ for holding the rewrite pointer P, a variable region PWD to which the rewrite pointer P and the XOR data of the rewrite pointer P are written, a variable region PRD to which the pointers P1 to Pn that are saved in the areas of the sector 2 are written, and a data write region PD for temporarily saving the true pointers P obtained by XORing the pointers P1 to Pn of the sector 2.

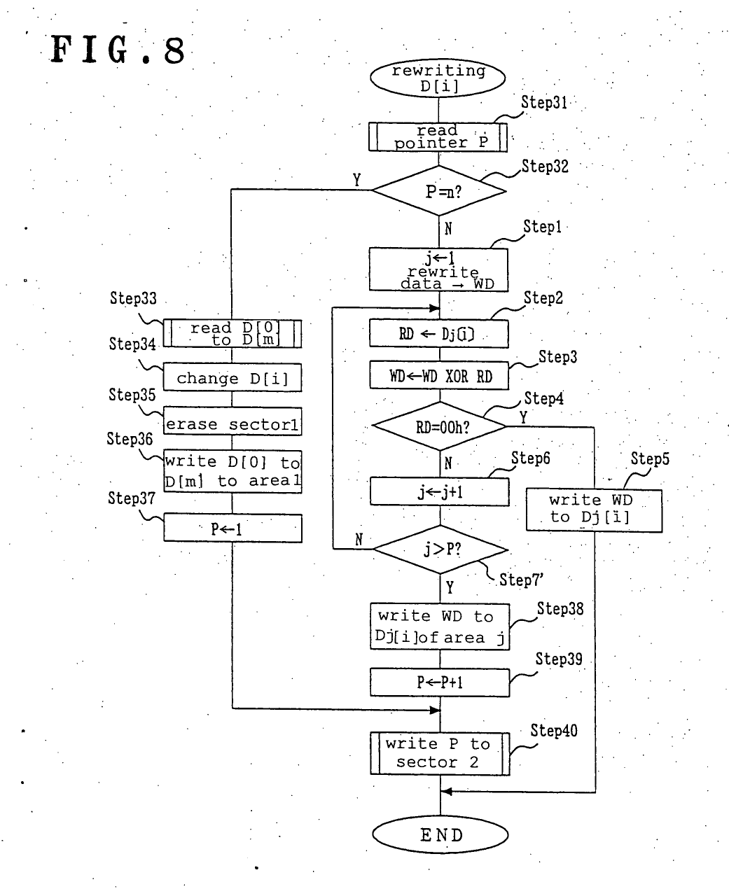

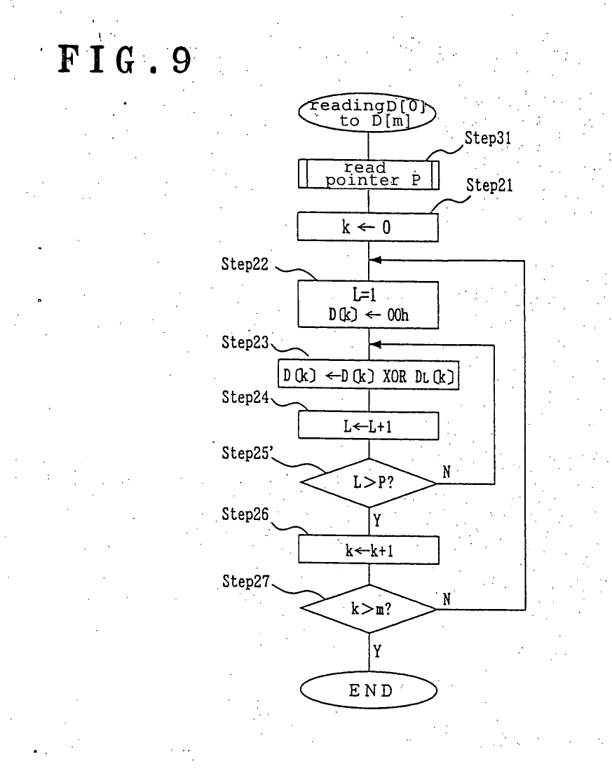

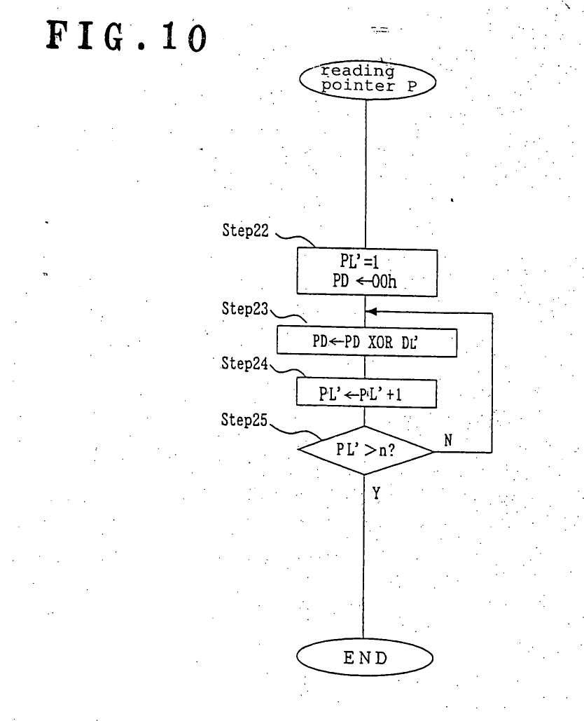

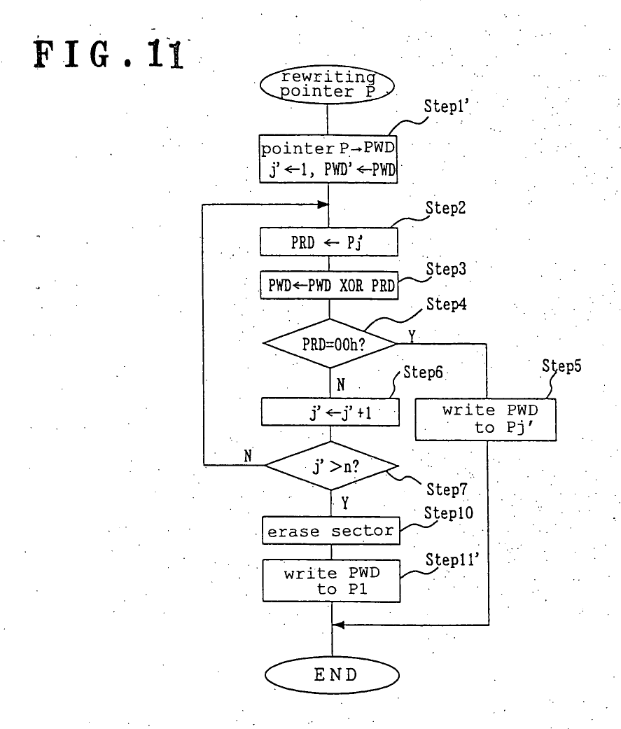

The operation of the system of the third embodiment is described next using the flowcharts of FIG. 8 to FIG. 11. FIG. 8 is a flowchart showing the operation when rewriting data, FIG. 9 is a flowchart showing the operation when reading data, FIG. 10 is a flowchart showing the operation when reading the pointers P, and FIG. 11 is a flowchart showing the operation when rewriting pointers P. It should be noted that some steps are the same as those shown in FIG. 2, FIG. 3, and FIG. 6 (Steps 1 to 7, Steps 10 and 11, and Steps 21 to 27), and thus a detailed description of those operations is omitted.

When a control portion (not shown) detects the input of one byte of rewrite data D[i], for example, the control portion stores the rewrite data D[i] in the variable region WD of the working memory 20 and enters the process for reading pointers P from the sector 2 (Step 31). With respect to this reading process, first, as shown in FIG. 10, the control portion writes a 1, which indicates the area number, to the variable region L′ of the working memory 20, and then writes the erased state of 00 h to the variable region PD (Step 22). Next, the control portion takes the XOR of the data P1 written to the first area of the sector 2 and the 00 h of the variable region PD and writes the resulting XOR data over 00 h of the variable region PD (Step 23). Then, the control portion increments the variable region L′ by 1 to 2 (Step 24) and determines if this value is greater than n (Step 25). At this point, the value of the variable region L′ is 2, and thus the procedure returns to Step 22 to repeat the above-described operation. In the course of this series of operations being repeated, when the value of the variable region L′ exceeds n, reading of the pointers P is ended. Through this reading process, the true pointer P is written to the variable region PD.

When this reading process is ended, the pointer P that has been read and the number of the areas n of the sector 1 are compared in Step 32 (FIG. 8). If P=n, then it is determined that data have been written through the area n and the procedure proceeds to Step 33, but if the pointer P is less than the number of the areas n of the sector 1, then it is determined that there are areas to which XOR data should be written among Dj[i], and the same process from Steps 1 to 6 of the first embodiment is performed. When this process is performed and it is determined in Step 4 that the data written to the variable region RD from the sector 1 are 00 h, then the XORed rewrite data WD are written to Dj[i] of 00 h (Step 5) and the rewriting process is ended. When the data of the variable region RD are not 00 h, then the variable region j (number of areas) is incremented by 1 (Step 6) and whether that value exceeds P is determined (Step 7′). When the value of the variable region j is equal to or less than P, then the procedure returns to Step 2 and the operation is repeated. When the value of the variable region j exceeds P, then it is determined that data are not written to the area j whose value is greater than P, and the XORed rewrite data WD are written to Dj[i] of the area j (Step 38). Then, the control portion increments the pointer P that has been read by 1 (Step 39) and proceeds to the process of writing that pointer number P to the sector 2 (Step 40).

On the other hand, when it is determined in Step 32 that P=n, then as mentioned above, it is determined that data are written up to the area n and all the data D[0] to D[m] are read from the sector 1 (Step 33) and stored in the data write region 21 of the working memory 20. This reading process will be described later using FIG. 9. Next, the rewrite data D[i] are written over D[i] of the data D[0] to D[m] stored in the data write region 21, thereby changing D[i] (Step 34). All the XOR data D1[0] to Dn[m] written to the sector 1 are erased (Step 35) and all the data D[0] to D[m] are written to the area 1 of the sector 1 (Step 36). Then, the pointer P is set to 1 (Step 37), and in the same manner as above, the control portion proceeds to the process for writing the pointer P (Step 40).

This process is basically the same as the rewriting process of the second embodiment described in FIG. 6, but since the variable regions that are used during the rewriting process are different, the process will be described using the flowchart shown in FIG. 11.

First, the pointer P obtained at Step 37 or Step 39 of FIG. 8 is written to the variable region PWD of the working memory 20 and then a 1 indicating the order of the area of the sector 2 is written to the variable region j′ of the working memory 20 and the pointer P is written to the variable region PWD′ of the working memory 20 (Step 1′).

Then, the pointer P1 written to the first area P1 of the sector 2 is written to the variable region PRD (Step 2) and the XOR (exclusive OR) of the pointer P and the pointer P1 written to the variable regions PWD and PRD, respectively, is taken, and the resulting XOR pointer is written over the pointer P in the variable region PWD (Step 3). Then, whether the pointer P1 written to the variable region PRD of the working memory 20 is 00 h is determined (Step 4). When the pointer P1 is not 00 h, then the variable region j′ is incremented by 1 to 2 (Step 6), whereas when the pointer P1 written to the variable region PRD is 00 h, the XOR pointer written to the variable region PWD is written over the first area P1 of the sector 2 (Step 5) and the above-described series of operations is ended.

When the area number j′ exceeds n without there being a pointer P of 00 h in the areas of the sector 2 (Step 2 to Step 7), then all the pointers P1 to Pn written to the sector 2 are erased (Step 10). Then, the pointer P for rewriting is read from the variable region PWD′ and written to the first area P1 of the sector 2 (Step 11′) and the process of rewriting the pointer P is ended.

On the other hand, if the true data D[0] to D[m] are to be read from the sector 1, then as shown in FIG. 9, first the pointer P is read according to the flowchart of FIG. 10 (Step 31). When reading of the pointer P is finished, substantially the same process as that of the first embodiment described in FIG. 3 is executed to read the true data D[0] to D[m] from the sector 1 (Step 21 to Step 27). The difference is that although in the first embodiment L, n were compared in Step 25, in the third embodiment, L, which indicates the area number, and P, which is the pointer number indicating the area number of the area in which data are written (Step 31), are compared in Step 25′. This comparison shows up to which area of the sector 1 data have been written, and minimizes the number of times that data are read from the areas to perform XOR.

As described above, according to the third embodiment, the same sector 1 for data writing as in the first embodiment and a sector 2 to which pointer data P of the areas of the sector 1 are written are prepared in the flash memory 10, and thus like the first embodiment, deterioration of the memory cells can be prevented and data can be rewritten in byte units or in word units without introducing select transistors. Moreover, since the data that are written to each sector are XOR values, an increase in security can also be achieved.

Also, by reading the pointer data P it is possible to quickly determine that the areas of the sector 1 are full and that data cannot be written, thereby allowing the processes for erasing and writing data to be carried out quickly. In addition, the areas that are used can be determined from the pointer data P when data reading is performed, so that unnecessary data reading and XORing can be eliminated and the data readout speed can be made faster.

### FOURTH EMBODIMENT

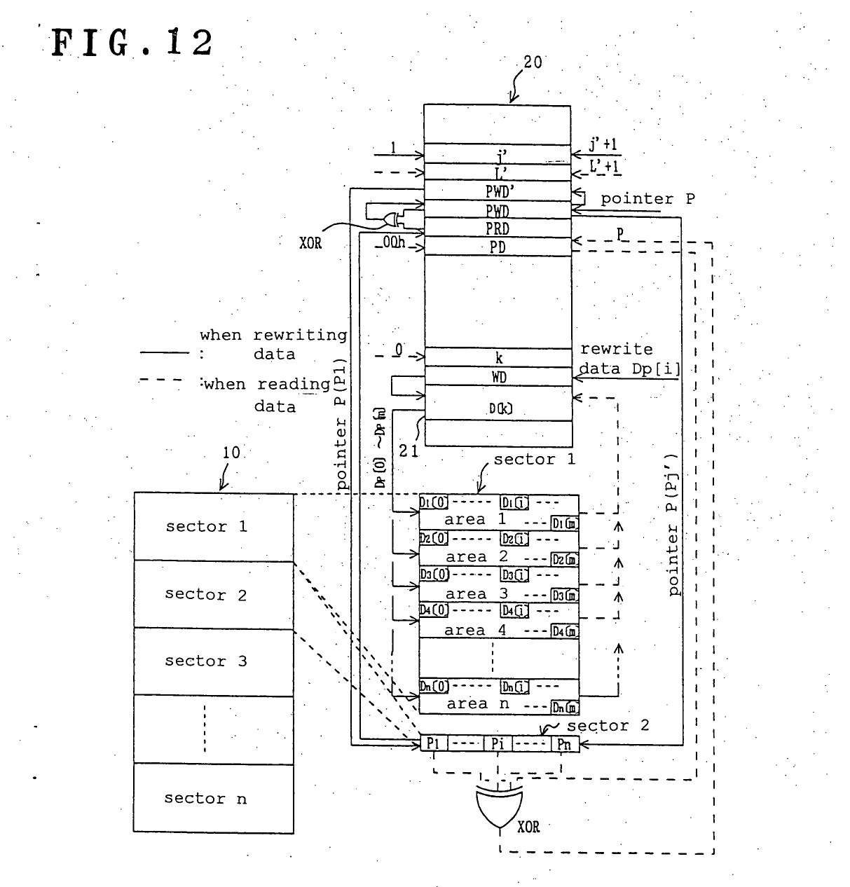

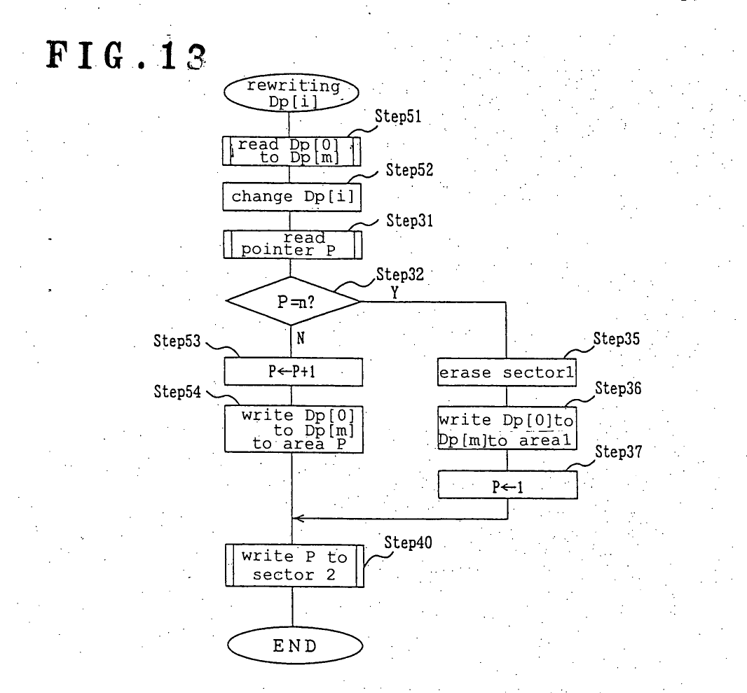

FIG. 12 is an explanatory diagram of a method for rewriting data in a memory according to a fourth embodiment of the present invention. It should be noted that components that are identical to or correspond to those of the first and third embodiments illustrated in FIG. 1 and FIG. 7 have been assigned identical reference numerals and description thereof is omitted.

The flash memory 10 according to the fourth embodiment, like in the third embodiment, has a sector 1 for data writing and a sector 2 for storing one-byte pointer data P (hereinafter, referred to simply as “pointer P”) indicating an area number of an area to which data are written. The sector 1, like in the first embodiment, is partitioned into a plurality of areas 1 to n each m bytes in size. Data that have been XORed are not written to the areas 1 to n; instead, true data are written directly to the areas 1 to n. The sector 2, like in the third embodiment, is made of n bytes and stores pointers P that have been XORed.

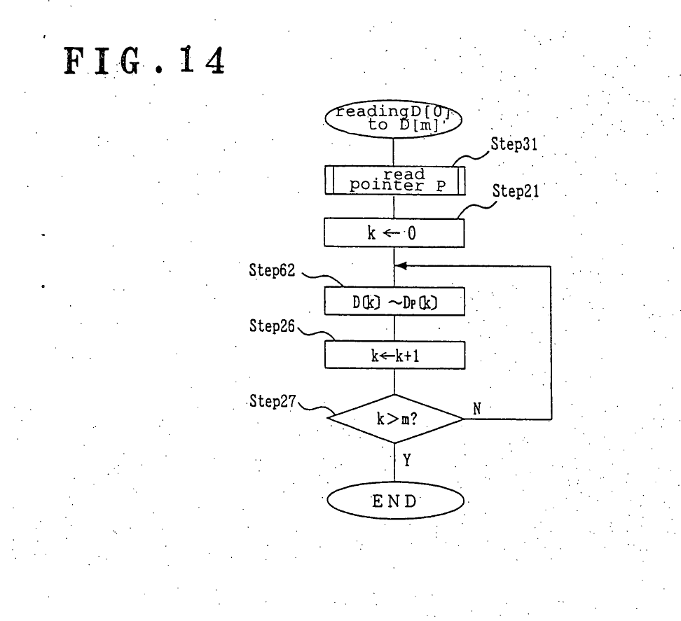

The operation of the system of the fourth embodiment is described next using the flowcharts of FIG. 13 and FIG. 14. FIG. 13 is a flowchart showing the operation when rewriting data according to the fourth embodiment, and FIG. 14 is a flowchart showing the operation when reading data according to the fourth embodiment. It should be noted that the description of steps that are the same as those in FIGS. 8 to 11 described in the third embodiment is omitted.

When a control portion (not shown) detects the input of one byte of rewrite data Dp[i], for example, the control portion temporarily stores the rewrite data Dp[i] in the variable region WD of the working memory 20, reads the data Dp[0] to Dp[m] from the areas corresponding to the pointers P (the area numbers) and stores the data Dp[0] to Dp[m] in the data write region 21 of the working memory 20 (Step 51). This reading process is discussed later using FIG. 14. Then, the rewrite data Dp[i] is written over the data Dp[i] of the data Dp[0] to Dp[m] stored in the data write region 21, thereby changing the data Dp[i] (Step 52). Next, the pointer P is read from the sector 2 (Step 31) and compared with the area number n of the sector 1 (Step 32). It should be noted that the procedure for reading out the pointer P is identical to that of the third embodiment and described with reference to FIG. 10, and thus description thereof is omitted.

If it is found that P=n in Step 32, then it is determined that areas up to the area n of the sector 1 are full with data and all the data written to the sector 1 are erased (Step 35). Then, the data Dp[0] to Dp[m] stored in the data write region 21 are written to the area 1 of the sector 1 (Step 36), the pointer P is set to 1 and the control portion advances to the process for data writing to the sector 2 (Step 40). This process is the same as that of the third embodiment and described in FIG. 11, and thus description thereof is omitted here.

On the other hand, when the pointer P and n are not equal, the control portion determines that there are empty areas and increments the pointer P by 1 (Step 53). The control portion writes the above-mentioned data Dp[0] to Dp[m] to the same area p as that value (Step 54), writes the pointer P that has been incremented by 1 to the sector 2 (Step 40), and ends the operation of rewriting data.

The operation of reading data is described next using FIG. 14. First, using the same method as that of the third embodiment and described in FIG. 10, the control portion reads the pointer P from the sector 2 (Step 31). Then, the variable region k, which indicates the order in which data are arranged in the areas 1 to n, is set to 0 (Step 21) and the first data Dp[0] of the area p specified by the pointer P is read and written to the data write region 21 of the working memory 20 (Step 62). Next, the variable region k is incremented by 1 to 2 (Step 26) and it is determined whether this value k is greater than the number of bytes m (Step 27). When the value k is greater than m, the operation is ended, but when the value k is not greater than m, it is determined that there are data in the same area p and the second data Dp[2] are read and written to the data write region 21 of the working memory 20 (Step 62). This series of operations is repeated until data written to the same area p are read out (Step 62 to Step 27).

As described above, in the fourth embodiment, the XOR is not taken when rewriting data or reading data as in the third embodiment but rather data are directly written to and read from the area of the sector 2 indicated by the pointer P. Thus, deterioration of the memory cells can be prevented, data can be rewritten in byte units or in word units without introducing select transistors, and it is not necessary to perform XOR when reading data. Therefore, data can be rewritten and read faster than in the third embodiment.

### FIFTH EMBODIMENT

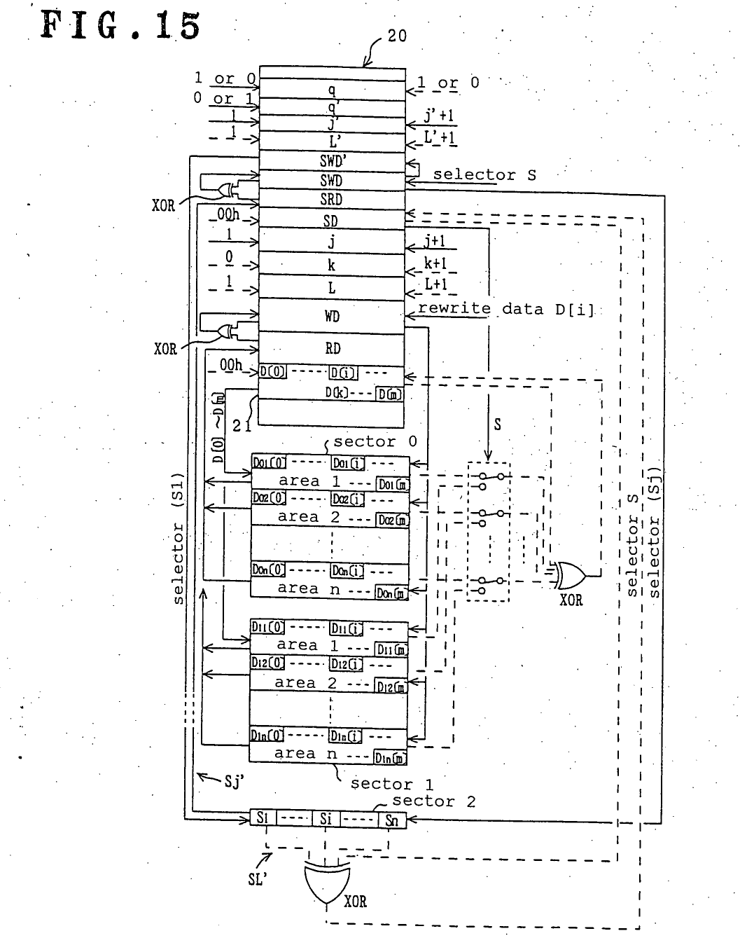

FIG. 15 is an explanatory diagram of a method for rewriting data in a memory according to a fifth embodiment of the present invention. It should be noted that components that are identical to or correspond to those of the first and third embodiments described in FIG. 1 and FIG. 7 have been assigned identical reference numerals and description thereof is omitted.

In the fifth embodiment, the flash memory 10 is provided with two sectors 0 and 1 to which data are written and a third sector 2 to which, for example, one-byte selector data S (hereinafter, referred to simply as “selector S” are written. The selector S is data for selecting the sector 0 or sector 1, and for example, if its value is an even number the sector 0 is selected and if its value is an odd number the sector 1 is selected.

The working memory 20 is provided with the same variable regions and the data storage region 21 as in the first embodiment, and additionally is provided with variable regions q and q′ to which a 1 or a 0 is written in correspondence with the selector S, a variable region j′ to which the area number of the sector 2 is written when rewriting the selector S, a variable region L′ to which the area number of the sector 2 is written when reading out the selector S, a variable region SWD′ for holding the rewrite selector S, a variable region SWD to which the rewrite selector S and XOR data of the rewrite selector S are written, a variable region SRD to which the selectors S1 to Sn stored in the areas of the sector 2 are written, and a data write region SD for temporarily storing the true selector S obtained by XORing the selectors S1 to Sn of the sector 2.

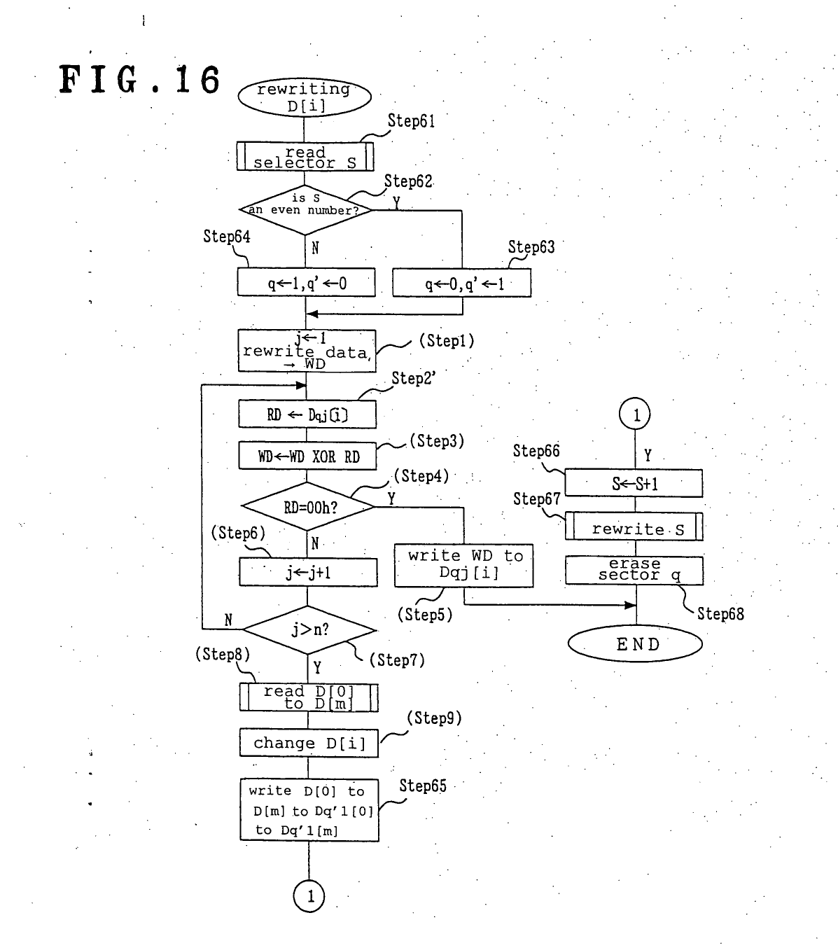

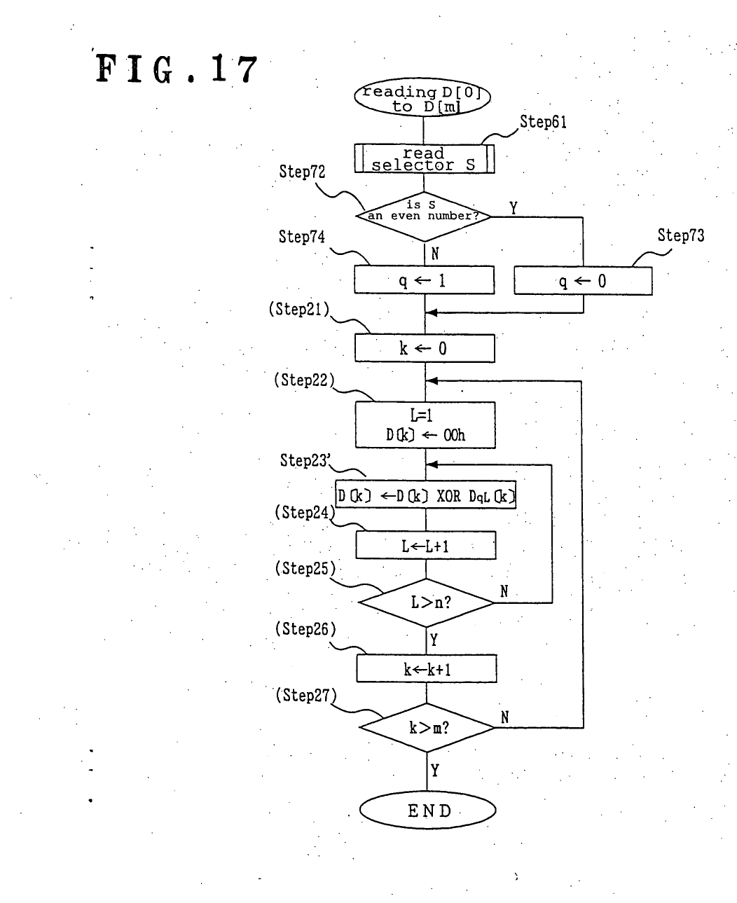

The operation of the system of the fifth embodiment is described next using the flowcharts of FIG. 16 and FIG. 17. FIG. 16 is a flowchart showing the operation when rewriting data according to the fifth embodiment, and FIG. 17 is a flowchart showing the operation when reading data according to the fifth embodiment. It should be noted that the steps in parenthesis in the diagrams are the same as those of the first embodiment described with reference to FIG. 2 and FIG. 3, and thus description of their operations is omitted here.

The control portion (not shown), when it detects the input of one byte of rewrite data D[i], for example, stores that rewrite data D[i] in the variable region WD of the working memory 20 and executes reading of the selector S from the sector 2 (Step 61). This reading is the same as that of the third embodiment described in FIG. 10, and in this diagram, PD has been replaced by SD and PL′ has been replaced by SL′. The control portion temporarily stores this true selector S read from the sector 2 through this reading process to the variable region SD and determines whether the selector S is an even number (Step 62). When the selector S is an even number, a 0 is written to the variable region q and a 1 is written to the variable region q′ in order to select the sector 0. When the selector S is an odd number, a 1 is written to the variable region q and a 0 is written to the variable region q′ in order to select the sector 1.

Next, the control portion executes the same operation as that of the first embodiment described in FIG. 2 (Step 1 to Step 7). If the sector 0 is selected in Step 62, then based on the 0 in the variable region q, data D01[i] . . . are read in sequence from the areas 1 to n of the sector 0 and XORed. When data of 00 h are found during this process, the rewrite data that have been XORed are written to that location and the operation is ended. On the other hand, when data other than 00 h are written to the areas 1 to n of the sector 0, then the true data D[0] to D[m] are read from the sector 0 and saved in the data write region 21 (Step 8), and the data D[i] of these data are overwritten and changed to the rewrite data D[i] of the variable region WD (Step 9). Then, the true data D[0] to D[m] are written to the area 1 of the other sector, i.e., the sector 1 (Step 65).

Next, if the sector 1 is selected in Step 62, then based on the 1 in the variable region q, data D11[i] . . . are read in sequence from the areas 1 to n of the sector 1 and XORed. When data of 00 h are found during this process, the XORed rewrite data are written to that location and the operation is ended. On the other hand, when data other than 00 h are written to the areas 1 to n of the sector 1, then the true data D[0] to D[m] are read from the sector 1 and saved in the data write region 21 (Step 8), and the data D[i] of these data are overwritten and changed to the rewrite data D[i] of the variable region WD (Step 9). Then, the true data D[0] to D[m] are written to the area 1 of the other sector, i.e., the sector 0 (Step 65). It should be noted that the operation of Step 8 is the same as that of the first embodiment described in FIG. 3, and Step 9 is the same as that of the first embodiment as mentioned above.

When the writing of data to the sector 0 or the sector 1 is finished, the value of the selector S in the variable region SD is incremented by 1 (Step 66) and the data writing operation for the selector S is performed (Step 67). This writing process is the same as that of the third embodiment that was described in FIG. 11, and is carried out with PWD, PWD′, Pj′, and PRD in the diagram being substituted for SWD, SWD′, Sj′, and SRD, respectively. The selector S that is written to the variable region SWD′ through this process is written to the first area of the sector 2. Then, the data D01[0] to D0n[m] of the sector 0 or the data D11[0] to D1n[m] of the sector 1 that were selected in Step 62 are erased (Step 68) and the process for rewriting data is ended. The reason why erasing of the data is performed last is because when the data are erased before being written to the area 1 of the other sector, the data are lost in case of interrupted processing due to a loss of power. The above erasure is performed last to prevent this.

The operation of reading out data is described next using FIG. 17. First, the selector S is read from the sector 2 as described in FIG. 16 and saved to the variable region SD of the working memory 20 (Step 61). Then, whether this selector S is an even number is determined (Step 72). When the selector S is an even number, a 0 is written to the variable region q (Step 73), whereas when the selector S is an odd number, a 1 is written to the variable region q (Step 74). If a 0 is written to the variable region q, then based on that variable the data D01[0] to D0n[m] written to the sector 0 are read and XORed and then temporarily stored in the data write region 21 (Step 21 to Step 27). If a 1 is written to the variable region q, then based on that variable the data D11[0] to D1n[m] written to the sector 1 are read and XORed and then stored temporarily in the data write region 21 (Step 21 to Step 27), and with this, the process of reading the data is ended. This process is the same as that of the first embodiment described in FIG. 3.

As described above, according to the fifth embodiment, two sectors 0 and 1 to which data are written, and a third sector 2 to which the selector S is written, are provided, and based on the selector S the sectors 0 and 1 are used in alternation, so that, like the first embodiment, a deterioration of the memory cells can be prevented, and data can be rewritten in byte units or in word units without introducing select transistors. Moreover, since the data that are written to each sector are XOR values, an improvement in security can be expected, and data are not erased even if the rewriting process is interrupted by power failure or the like.

### SIXTH EMBODIMENT

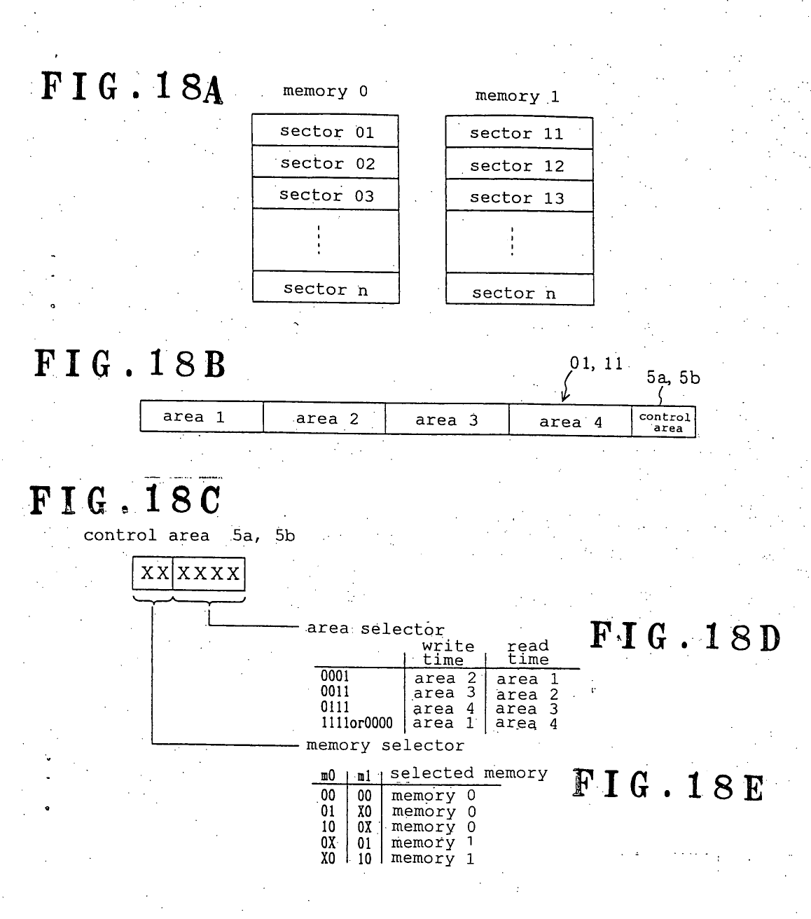

FIG. 18 is an explanatory diagram of a method for rewriting data in a memory according to a sixth embodiment of the present invention.

In the sixth embodiment, as shown in FIG. 18A, there are two flash memories 0 and 1 (hereinafter, these are referred to simply as “memories”) having a plurality of sectors 01 to n and 11 to n, respectively, and the first sectors 01 and 11 of these memories 0 and 1 are used as data storage areas, respectively. Each of the sectors 01 and 11, as for example shown in FIG. 18B, is made of the four areas 1 to 4 each capable of storing a predetermined length of data and a control area 5a or 5b. The control area 5a (5b) is made of a two-bit memory selector and a four-bit area selector, as shown in FIG. 18C. It should be noted that the control area 5a is provided in the sector 01 of the memory 0 and the control area 5b is provided in the sector 11 of the memory 1.

The two-bit value of the memory selector of the control area 5a (5b) is for selecting either the memory 0 or the memory 1, and is used for selection with the combination of the values serving as a key. For example, when the memory selector of the memory 0 (m0) is 01 and the memory selector of the memory 1 (m1) is X0, then the memory 0 is selected and the variable j is set to 0. When the memory selector of the memory 0 is 0X and the memory selector of the memory 1 is 01, then the memory 1 is selected and the variable j is set to 1. The values of the memory selectors and the memory numbers (see FIG. 18E) are stored as data in a ROM (not shown) and the variable j is written to a predetermined area in the working memory (not shown).

The four-bit value in the area selector of the control area 5a (5b) is for selecting the area and is different depending on whether data area is rewritten or read. For example, when rewriting data, if the memory 0 is selected in accordance with the memory selector of the control area 5a (5b), then the area number of the sector 01 of the memory 0 is determined based on the value that is written to the area selector of the control area 5a of the memory 0. This area number is written to a predetermined area in the working memory as the variable k, and the value of the area selector and the area number (see FIG. 18D) are stored in the ROM as data in a similar manner to that shown in FIG. 18E.

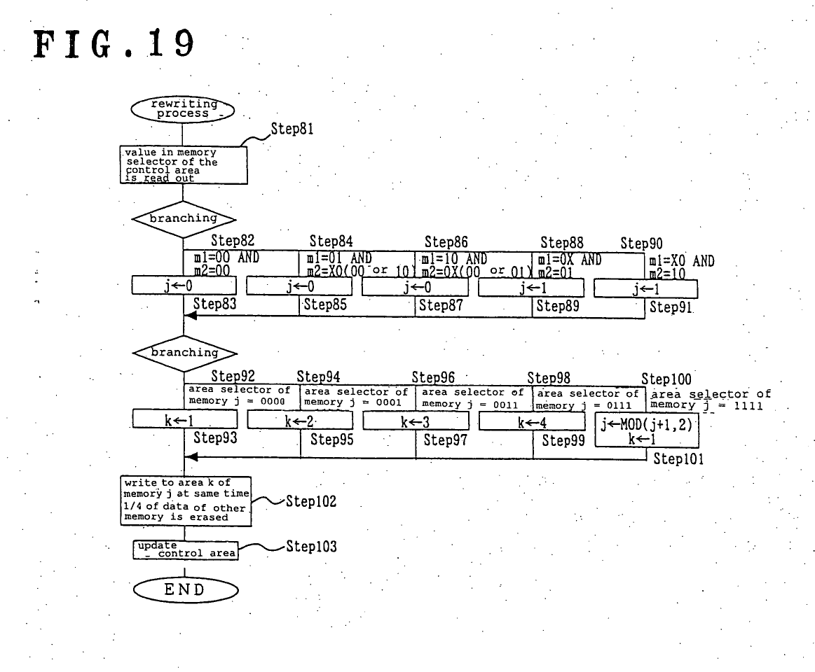

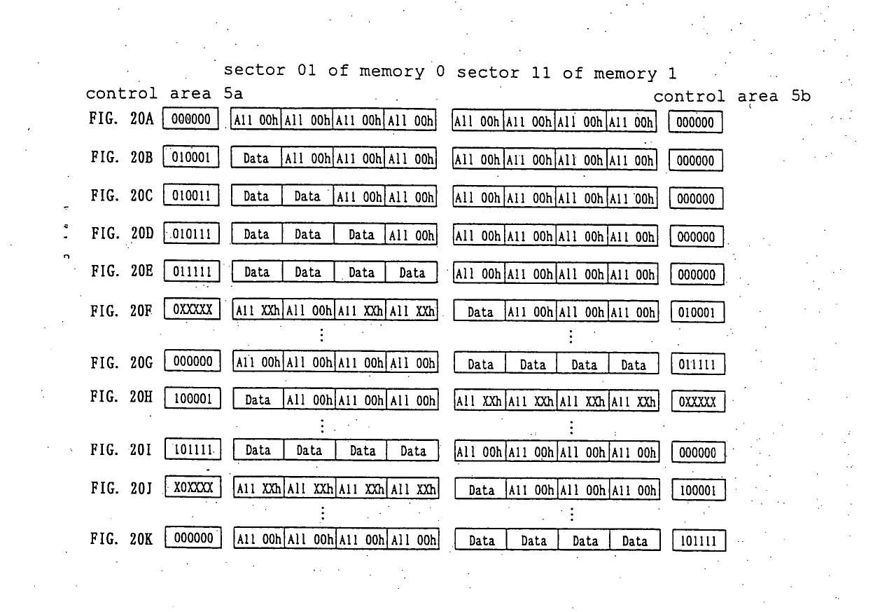

The operation of the system of the sixth embodiment is described next using FIG. 19 and FIGS. 20A to 20K. FIG. 19 is a flowchart showing the operation when rewriting data according to the sixth embodiment, and FIGS. 20A to 20K is a set of diagrams showing the states of the sectors based on the data rewriting process. It should be noted that for the sake of simplifying description of the operations, the areas 1 to 4 of each of the sectors 01 and 11 are all in the erased state 00h (FIG. 20A).

When data are to be rewritten for a first time, first the control portion reads the values of the memory selectors of the control areas 5a and 5b of the sectors 01 and 11 (Step 81) and advances the procedure to selection of the memory number. At this point, since the values of the memory selectors are both 00 as described above, the control portion selects the memory 0 in Step 82 and sets the variable j to 0 (Step 83). When the memory 0 is selected, the value of the area selector of the sector 01 is read and the procedure moves to the determination of the area number for data writing. At this time, since this value is 0000, the area 1 is selected in Step 92 and the variable k is set to 1 (Step 93).

Due to the above determinations, data are written to the area 1 of the sector 01 of the memory 0 and the data written to the sector 11 of the other memory, i.e., the memory 1, are erased at one-quarter of the time (Step 102). Here, the data in the area 1 of the sector 11 are erased so that the erasing process is performed without determining whether data are written to the area 1. As regards the erasing of those data, for example, if the erase time is set to 10 mS and the write time is set to 20 μm, then a data erase time of 2.5 mS is sufficient, and since the write speed is fast, writing can be completely performed during the erasing. Also, by employing the two memories, writing and erasing can be carried out substantially concurrently.

When writing of the data is finished, the values in the control area 5a of the sector 01 are updated (Step 103). This process is also carried out during the 2.5 mS of erasing process, and updating involves only changing 0s to 1s and is not accompanied by erasing. Here, the value 00 of the memory selector of the control area 5a is changed to 01 and the value 0000 of the area selector is changed to 0001, which indicates the next write area. With this the first rewriting is completed, and the state shown in FIG. 20B is achieved.

Next, in the second rewriting of data, in the same manner as described above, the control portion reads the values of the memory selectors of the control areas 5a and 5b (Step 81) and advances the procedure to the selection of the memory number. In this case, the memory selector of the control area 5a is 01 and the memory selector of the control area 5b is 00, and thus the memory 0 is selected in Step 84 and the variable j is set to 0 (Step 85). Then, the control portion reads the value in the area selector of the memory 0 that has been selected and proceeds to the determination of the area number for data writing. At this time, since that value is 0001, the area 2 is determined in Step 94 and the variable k is set to 2 (Step 95).

Then, data are written to the area 2 of the sector 01 of the selected memory, i.e., the memory 0, and the data written to the sector 11 of the other memory, i.e., the memory 1, are erased at one-quarter of the time (Step 102). Next, the value 01 of the memory selector of the control area 5a of the memory 0 is maintained and the value 0001 of the area selector is changed to 0011 (Step 103), thereby completing the second rewriting. The state at this time is shown in FIG. 20C.

In the third rewriting of data, the procedure proceeds from Step 81 to Step 84, and the variable j, which indicates the memory number, is set to 0 (step 85). Since the value of the area selector of the memory 0 is 0011, the procedure proceeds from Step 96 to Step 97 and the variable k, which indicates the area number, is set to 3. Then, data are written to the area 3 of the sector 01 of the memory 0 and one-quarter of the data written to the sector 11 of the other memory, i.e., the memory 1, are erased (Step 102) and the value of the control area 5a of the memory 0 is changed. In this case, the value 01 of the memory selector is maintained and the value 0011 of the area selector is changed to 0111 (Step 103), thereby completing the third rewriting (see FIG. 20D).

In the fourth rewriting of data, the procedure moves from Step 81 to Step 84 and to Step 85, thereby setting the variable j to 0, and then, due to the value of 0111 in the area selector of the memory 0, the procedure proceeds from Step 98 to Step 99 to set the variable k to 4. Then, due to this determination, data are written to the area 4 of the sector 01 of the memory 0 and the remaining one-quarter of data written to the sector 11 of the memory 1 are erased (Step 102) and the value of the control area 5a of the memory 0 is changed. In this case, the value 01 of the memory selector is maintained and the value 0111 of the area selector is changed to 1111 (Step 103), thereby completing the fourth rewriting (see FIG. 20E). Thus, a state where data are written to all the four areas 1 to 4 of the memory 0 is arrived at.

In the case of the fifth rewriting of the data, the values of the memory selectors of the control areas 5a and 5b are read out (Step 81). At this time, as shown in FIG. 20E, the memory selector of the control area 5a is 01 and the memory selector of the control area 5b is 00, so that the memory 0 is selected in Step 84 and the variable j is set to 0 (Step 85). Then, the value of the area selector of the memory 0 that is selected is read and the procedure is moved to the determination of the number of the area to which data are to be written. At this time the value of the area selector of the memory 0 is 1111 and thus in Step 100 a 1 is added to the variable j that has been set to 0 in Step 85 and the resulting value is divided by 2 and the MOD (remainder) is set as the variable j. At this time, since the MOD is 1, the variable j, which indicates the memory number, is changed to 1 and the variable k, which indicates the area number, is set to 1.

After this process, data are written to the area 1 of the sector 11 of the memory 1 and the data that are written to the sector 01 of the memory 0 are erased (Step 102). In this case as well, the erase time is 2.5 mS (one-quarter time erasure), but since there are discrepancies in the erase time among memory cells, the data of the sector 01 of the memory 0 are uncertain, and this results in the state shown in FIG. 20F. After the data are written to the area 1 of the memory 1, then, in the same way as was described above, the value 00 of the memory selector of the control area 5b is changed to 01 and the value 0000 of the area selector is changed to 0001, which indicates the next write area (Step 103). With this, the fifth rewriting is completed (see FIG. 20F).

To rewrite data subsequent to this, data are written in order from the area 2 of the sector 11 of the memory 1. In the case of the eighth rewriting of data, the data are written to the area 4 of the sector 11 of the memory 1 and the value 01 of the memory selector of the control area 5b is maintained while the value of the area selector is changed to 1111. At this time, the sector 01 of the memory 0 has been subjected to erasing for a total of 10 mS, that is, 2.5 mS×four times, and is in the completely erased state 00 h (see FIG. 20G).

In the case of the ninth rewriting of the data, as shown in FIG. 20G, the memory selector of the control area 5a is 00 and the memory selector of the control area 5b is 01, and thus the memory 1 is selected in Step 88 and the variable j is set to 1 (Step 85). However, since the value of the area selector of the memory 1 is 1111, in Step 100, a 1 is added to the variable j of 1 that was set in Step 89 and the resulting value is divided by 2 and the MOD (remainder) is set as the variable j. At this time, since the MOD is 0, the variable j, which indicates the memory number, is changed to 0 and the variable k, which indicates the area number, is set to 1. In other words, the memory is changed from memory 1 to memory 0, and the number of the area is set to 1.

After this process, data are written to the area 1 of the sector 01 of the memory 0 and the data that are written to the sector 11 of the memory 1 are erased (Step 102). In this case as well, there are discrepancies in the erase time among memory cells and thus the data of the sector 11 of the memory 1 is uncertain, resulting in the state shown in FIG. 20H. Then, in the same way as was described above, the value of the memory selector of the control area 5a is changed to 10 and the value 0000 of the area selector is changed to 0001 (Step 103), and with this, the ninth rewriting is completed (see FIG. 20H). The resulting change of the memory selector of the control area 5a is obtained by shifting (or rotating) the values of the memory selector of the control area 5b of the memory 1 once to the left. Then, the rewriting process is repeated similarly. When the sector 01 of the memory 0 becomes full, the erasing of the sector 11 of the memory 1 is completed (see FIG. 20I).

In the case of rewriting data after this, the memory is switched from the memory 0 to the memory 1 in Step 100 as mentioned above and the rewriting of data is repeated (see FIGS. 20J and 20K). When the sector 11 of the memory 1 becomes full, the memory in use (or duty memory) is switched to the memory 0 from the memory 1, and the rewriting of data is once again repeated from FIG. 20B (see FIGS. 20B to 20K).

The operation of reading data is described next with reference to the flowchart shown in FIG. 21.

For example, in the case of reading data when the sectors 01 and 11 of the memories 0 and 1 are in the state shown in FIG. 20E, first, the values of the memory selectors of the control areas 5a and 5b of the sectors 01 and 11 are read (Step 111) and the procedure is moved to the selection of the memory number. At this time, the memory selector of the control area 5a is a value of 01 and the memory selector of the control area 5b is a value of 00, so that the memory 0 is selected in Step 114 and the variable j is set to 0 (Step 115). If the memory 0 is selected, then the value that is written to the area selector of the sector 01 is read and the procedure moves to the determination of the number of the area from which to read data. At this time, since that value is 1111, it is determined in Step 130 that the area is the area 4, and the variable k is set to 4 (Step 131). Based on the above determination, the data most recently written to the area 4 of the sector 01 of the memory 0 are read (Step 132) and the above-described series of operations is completed.

As described above, in the sixth embodiment, two memories (flash memories) 0 and 1 are prepared, each of the sectors 01 and 11 is partitioned into a plurality of areas 1 to 4 having a predetermined data length, and a control area 5a (5b) is provided. Concurrent to additional writing to an area of one memory, the erasing of sectors of the other memory is performed piecemeal (stepwise). When data are written to the areas of a sector of the one memory, the erasing of a sector of the other memory is completed, so that data are written to the two memories in alternation, thus significantly shortening the time for rewriting data.

Also, in the first through fifth embodiments described above, although the normal rewrite time is short, it is necessary to erase the sector when the areas are full, and thus rewriting in this situation cannot be shortened. In the sixth embodiment, however, erasing is performed in piecemeal fashion at the same time the data are written, and thus the rewrite time can be shortened for all rewriting of data.

Furthermore, in the sixth embodiment, data can be rewritten in byte or word units without adding select transistors, and the configuration of the memory cells can be made simple. Also, since data is written successively into the areas within the sectors, it is possible to reduce the number of times the rewriting is carried out and the deterioration of the memory cells can be prevented.

### SEVENTH EMBODIMENT

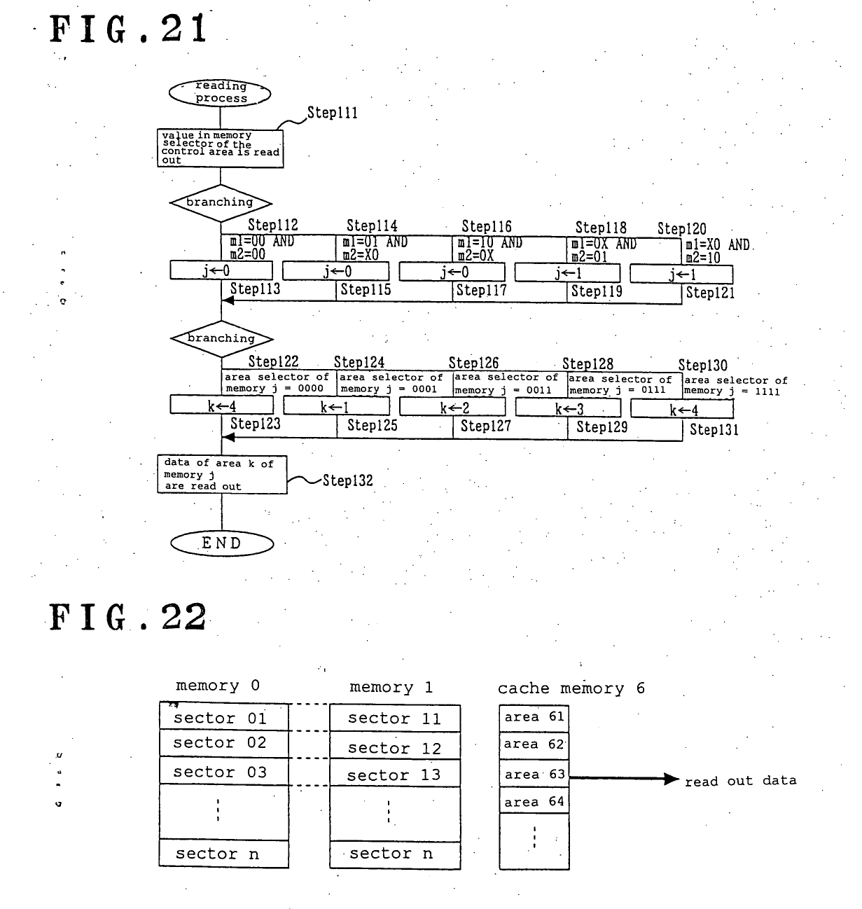

FIG. 22 is an explanatory diagram of a method for rewriting data in a memory according to a seventh embodiment of the present invention.

In the seventh embodiment, the system includes two flash memories 0 and 1 having a plurality of sectors 01 to n and 11 to n, and a cache memory 6. The sectors 01 and 11 of the two flash memories 0 and 1 have the same configuration as described above in the sixth embodiment; the sector 01 (11) has four areas 1 to 4 and a control area 5a (5b). The cache memory 6 has the same data capacity as the flash memories 0 and 1, and is provided with the areas 61 to 64 corresponding to the areas 1 to 4 provided in the sectors 01 and 11.

The operation of the system is described next. The data rewrite operation according to this embodiment is very similar to that of the sixth embodiment. However, when data are written to the area 3 of one of the flash memories 0 or 1, for example, then the same data are also stored in the area 63 of the cache memory 6, which corresponds to the area 3. When reading the data, the data are not read from the flash memory 0 (or 1) but rather the latest data stored in the cache memory 6 are read out. It should be noted that when the power is turned on, it is necessary to perform a process for reading the most recent data stored in the flash memory 0 or the flash memory 1 using the reading method illustrated in the sixth embodiment and storing them in the cache memory 6.

As described above, according to the seventh embodiment, the cache memory 6 is added to the configuration of the sixth embodiment and when rewriting data to either the flash memory 0 or the flash memory 1, the most recent data are stored in the cache memory 6, so that not only are the same effects as in the sixth embodiment achieved but the process for reading out data is simplified and the reading speed is increased. Also, since data are read from the cache memory 6, the amount of power consumed when reading data can be reduced.

It should be noted that in the first through seventh embodiments, the process of rewriting and the process of reading the flash memory were described as shifting achieved through a control portion such as a CPU and a control program, but this is not a limitation, and it is also possible to carry out these processes using hardware. Also, the erased state was 0 and the written state was 1 in the foregoing description, but this is not a limitation. If in the first through fifth embodiments the erased state is 1, then on account of X0R addition writing, it is necessary to make n an odd number, or if n is an even number, to perform XOR.

In the first through fifth embodiments, it is possible to provide a cache memory 6 like that of the seventh embodiment in order to speed up the reading process. In the sixth embodiment the number of areas in a single sector is four, but this is not a limitation, and the sector, can be divided to other than four as long as the total amount of time when performing erasing piecemeal is the amount of time required for erasing. Using this method, it is theoretically possible to shorten the time for rewriting down to the time that is required for writing.

This application is based on a Japanese Patent Application No. 2003-274737, and the entire disclosure thereof is incorporated herein by reference.

1. A method of writing rewrite data over existing data in a memory, the memory having a sector partitioned into a plurality of areas, the existing data being written at a same position in the respective areas, the method comprising:
taking an exclusive-OR of the rewrite data and existing data at a target position in a first area;
taking an exclusive-OR of the exclusive-OR data, which is obtained by the previous exclusive-OR process, and existing data at the target position in a second area; and
performing a similar exclusive-OR process up to a final area, wherein in the course of repeating these exclusive OR processes, when the data at the target position in the area concerned are an initial value, then the most recent exclusive-OR data are written to the target position in the area concerned.

2. The method of writing rewrite data according to claim 1, wherein if there is no initial value when the exclusive-OR process is carried out up to the final area, then for a same position in each of the areas, an exclusive-OR of data in the first area and data in the second area is taken, an exclusive-OR of the resulting exclusive-OR data and data in a third area is taken, and a similar exclusive-OR process is performed up to the final area so that all data within the sector are read and the data at the target positions are changed to the rewrite data, and then, all the data within the sector are erased and all new data, including the rewrite data, are written to the first area in the sector.

3. A method of writing rewrite data over existing data in a memory, the memory having a sector partitioned into a plurality of areas to which the existing data have been written, the method comprising:
taking an exclusive-OR of the rewrite data and existing data in a first area of the sector;
taking an exclusive-OR of the exclusive-OR data, which is obtained by the previous exclusive-OR process, and existing data in a second area; and
performing a similar exclusive-OR processes up to a final area, wherein in the course of repeating these exclusive-OR processes, when the data in the area concerned are an initial value, the most recent exclusive-OR data is written to the area concerned.

4. The method of writing rewrite data according to claim 3, wherein if there is no initial value when the exclusive-OR process is carried out up to the final area, all the areas within the sector are erased and the rewrite data are written to the first area of the sector.

5. A method of writing rewrite data over existing data in a memory, the memory having a sector and a pointer sector, the sector being partitioned into a plurality of areas, the existing data being written to the plurality of areas, a plurality of pointer data being written to the pointer sector such that the pointer data designate area numbers of the areas of the sector respectively, the method comprising:
taking an exclusive-OR of first pointer data and second pointer data in the pointer sector;
taking an exclusive-OR of the exclusive-OR pointer data, which is obtained by the previous exclusive-OR process, and third pointer data; and
performing a similar exclusive-OR processes up to final pointer data to read an ultimate area number, wherein the existing data are read from the area of the sector based on the ultimate area number, an exclusive-OR of this existing data and the rewrite data is taken to prepare new rewrite data, and then, when the area number is smaller than a number of the areas of the sector, the area number is incremented by 1 and the new rewrite data is written to the area of the incremented area number, and when the area number is equal to the number of the areas, all data within the sector are erased, the new rewrite data is written to the first area of the sector and the area number is set to 1.

6. The method of writing rewrite data according to claim 5, wherein when writing the area number that has been incremented by 1 or an area number of 1 to the pointer sector, an exclusive-OR of that area number and the first pointer data of the pointer sector is taken, an exclusive-OR of that exclusive-OR pointer data and the second pointer data is taken, a similar exclusive OR process is performed successively up to the final pointer data, and in the course of repeating these exclusive OR processes, when the pointer data are an initial value, the most recent exclusive-OR pointer data are written over the pointer data, and when there is no initial value when the exclusive OR process is carried out up to the final pointer data, all pointer data within the pointer sector are erased and then the area number is written to the first area of the pointer sector.

7. A method of rewriting data in a memory, the memory having two sectors and a selector sector, each of the two sectors partitioned into a plurality of areas such that the data are written at identical positions in the respective areas, a plurality of selector data for selecting one of the two sectors being written to the selector sector, the method comprising:
taking an exclusive-OR of first selector data and second selector data in the selector sector;
taking an exclusive-OR of the exclusive-OR selector data, which is obtained by the previous exclusive-OR process, and third selector data;
performing a similar exclusive-OR process up to final selector data to read sector selection data, wherein an exclusive-OR of data at a target position in a first area of one of the two sectors designated by the sector selection data and rewrite data is taken, an exclusive-OR of the resulting exclusive-OR data and data at the target position in a second area of the same sector is taken, a similar exclusive-OR process is performed up to a final area, and in the course of performing these exclusive-OR processes, when data at the target position in an area is an initial value, then the most recent exclusive-OR data is written to the target position of that area.

8. The method of rewriting data in a memory according to claim 7, wherein when there is no initial value when the exclusive OR process has been carried out up to the final area, then, for each same position in the areas, an exclusive-OR of a data in the first area and data in the second area is taken, an exclusive-OR of that exclusive-OR data and data in the third area is taken, a similar exclusive-OR process is performed up to the final rear so as to read all data from the sector, the data at the target position are changed to the rewrite data, all new data, including the rewrite data, are written to the first area of the other sector and the sector selection data is incremented by 1.

9. The method of rewriting data in a memory according to claim 8, wherein when the sector selection data is incremented by 1, an exclusive-OR of the incremented sector selection data and the first selector data of the selector sector is taken, an exclusive-OR of that exclusive-OR selector data and the second selector data is taken, a similar exclusive-OR process is performed up to the final selector data, and in the course of performing these exclusive-OR processes, when the selector data is an initial value, the most recent exclusive-OR selector data is written over that selector data, and when there is no initial value when the exclusive OR process has been carried out up to the final selector data, all selector data within the selector sector are erased and then the sector selection data are written to the first area of the selector sector.

10. A method of rewriting data in two memories, each of the two memories having a sector, the sector having a plurality of areas to which data are written and a control area to which memory selection data and area designation data are written, the method comprising:
A) selecting one of the two memories based on memory selection data in the control areas of the two memories;
B) writing rewrite data to an area determined by the area designation data in the control area of the selected memory;
C) erasing data in the areas of the other memory in a piecemeal manner;
D) repeating the steps B and C until the rewrite data are written to all the areas of the selected memory, such that erasing of the data within all the areas of the other memory is completed when the rewrite data are written to all the areas of the selected memory; and
E) switching the roles of the two memories and repeating the steps B, C and D so that the rewrite data are written to the two memories in alternation.

11. The method of rewriting data in two memories according to claim 10, wherein a cache memory is provided in addition to the two memories, so that when the rewrite data is written to one of the two memories, the same rewrite data are also written to the cache memory, and wherein when the rewritten data should be read from that memory, the rewrite data are read from the cache memory, not from that memory.

12. A method of writing rewrite data over existing data in a memory, the memory having a sector and a pointer sector, the sector being partitioned into a plurality of areas, the existing data being written to the plurality of areas, a plurality of pointer data being written to the pointer sector such that the pointer data designate area numbers of the areas of the sector respectively, the method comprising:
taking an exclusive-OR of first pointer data and second pointer data in the pointer sector;
taking an exclusive-OR of the exclusive-OR pointer data, which is obtained by the previous exclusive-OR process, and third pointer data; and
performing a similar exclusive-OR processes up to final pointer data to read an ultimate area number, wherein when the ultimate area number is smaller than a number of the areas of the sector, the ultimate area number is incremented by 1 and the rewrite data is written to the area of the incremented area number, and when the ultimate area number is equal to the number of the areas, all data within the sector are erased, the rewrite data is written to the first area of the sector and the ultimate area number is set to 1.
